(19) United States
(12) Patent Application Publication
(10) Pub. No.: US 2021/0232956 A1
(43) Pub. Date: Jul. 29, 2021

(54) EVENT CORRELATION BASED ON PATTERN RECOGNITION AND MACHINE LEARNING

(71) Applicant: GAVS Technologies Pvt. Ltd., CHENNAI (IN)

(72) Inventors: GIREESH SREEDHAR, CHENNAI (IN); NARESH BHASKAR, CHENNAI (IN); VIMALRAJ SUBASH, CHENNAI (IN); GOKUL PAULCHAMY, CHENNAI (IN)

(21) Appl. No.: 17/159,618

(22) Filed: Jan. 27, 2021

(30) Foreign Application Priority Data
Jan. 27, 2020 (IN) 202041003636

(51) Int. Cl. G06N 5/04; G06F 16/215; G06F 16/28; G06N 20/00

(52) U.S. Cl. CPC G06N 5/047; G06N 20/00; G06F 16/285; G06F 16/215

(57) ABSTRACT

A method and a system of improving correlation of events and alerts in or more enterprise networks (103) are disclosed. The method includes receiving, by a processor (402), event data from a plurality of devices (104) in the network (103), wherein the event data comprises one or more of performance metrics data, alerts data, and incident data. The event data is cleaned based on predetermined input parameters and the cleaned event data is labeled based on predetermined definitions. The method further includes performing sequence pattern identification to identify patterns in the labeled event data. The recurring identified patterns are clustered to obtain correlated events. The method includes improving the accuracy of the correlated events using reinforcement learning.

### CROSS-REFERENCES TO RELATED APPLICATION

This application claims priority to Indian patent application No. 202041003636, filed on Jan. 27, 2020, the full disclosure of which is incorporated herein by reference.

### FIELD OF THE INVENTION

The disclosure generally relates to information technology service management and, in particular, to methods and systems for improving correlation of events and alerts in enterprise networks using reinforcement learning.

### DESCRIPTION OF THE RELATED ART

Information Technology (IT) operations deal with a lot of events and alerts on a day to day basis. Particularly, IT service management (ITSM) involve incident and problem management with the aim to identify, log, isolate and perform remedial measures in the IT infrastructure environment to ensure spontaneous delivery of services and maintain the IT operation status as “business as usual”.

Traditional incident management depends on a configuration management database (CMDB) for correlation that captures blueprint of the IT infrastructure and defines a class relationship between the assets. However, CMDB technologies require continuous upgrade of the database and asset class relationships, and automated blueprint modeling of the IT infrastructure, which exposes sensitive data and information through sniffing of packet data.

Some of the incidents include abnormal resource utilization, unanticipated downtime or outages, generation of false positives, increase in noise, and the like. Timely, identification and resolution of issues forms an important part in achieving maximum business uptime and glitch free business operation. The biggest pain point is to identify the root cause of the incident that has caused an outage or unplanned downtime for an application or device.

Data generated from all the devices in an enterprise are of very large volume, which makes it hard for the engineer or operations team to narrow down the real root cause of the problem. This leads to increased time in resolving an issue or incident.

Various publications have attempted to address some of the challenges. US10102054B2 (Wolf al) describes anomaly detection, alerting, and failure correction in a network. US9652316B2 (Damage et al) relates to preventing and servicing system errors with event pattern correlation. Similarly, U.S. Pat. No. 7,318,178B2 relates to improved techniques for reducing false alarms in such systems by a finer correlation of variables. However, these publications do not address the challenges of performing event correlation between alerts and incidents from multiple sources to identify the root cause efficiently and effectively for mitigating the challenges faced by IT operations team and enabling quick and prompt action for remedial measures on the root cause of the issue.

### SUMMARY OF THE INVENTION

The present subject matter relates to methods and systems for improving correlation of events and alerts in enterprise networks.

According to one embodiment of the present subject matter, a computer implemented method of improving correlation of events and alerts in one or more enterprise networks is disclosed. The method includes receiving, by a processor, event data from a plurality of devices in the network, wherein the event data comprises one or more of performance metrics data, alerts data, and incident data. Next, the method involves cleaning, by the processor, the event data based on predetermined input parameters and labeling, by the processor, the cleaned event data based on predetermined definitions. The method further includes performing, by the processor, sequence pattern identification to identify, patterns in the labeled event data, and clustering, by the processor, recurring identified patterns to obtain correlated events. The method includes improving, by the processor, the accuracy of the correlated events using reinforcement learning.

In some embodiments, a state, an action, and a reward is applied to the correlated events, and wherein the state is the identified pattern and the action comprises improving the accuracy by tuning support parameters, windows length, and definitions. In some embodiments, outcome from the action is applied as: positive reward if there is an increase in accuracy; or negative reward if there is a decrease in accuracy. In some embodiments, labelling the cleaned event data includes: grouping alerts based on similarity of alert descriptions using K-means clustering; assigning a label to each group based on alert creation timestamp; and creating predetermined definitions based on one or more attributes, wherein the predetermined combinations comprise tool name, application name, or device name. In some embodiments, cleaning the event data is performed using keyword spotting and entity extraction methods.

According to another embodiment of the present subject matter, a system for improving correlation of events and alerts in one or more enterprise networks is disclosed. The system includes a processor; a memory unit coupled to the processor, wherein the processor is configured to: receive event data from a plurality of devices in the network, wherein the event data comprises one or more of performance metrics data, alerts data, and incident data. The processor is configured to clean the event data based on predetermined input parameters. The processor is configured to label the cleaned event data based on predetermined definitions. The processor is configured to perform sequence pattern identification to identify patterns in the labeled event data. The processor is configured to cluster recurring identified patterns to obtain correlated events; and improve the accuracy of the correlated events using reinforcement learning.

In some embodiments, the memory unit further includes: an event monitoring module configured to monitor the event data obtained from a plurality of monitoring agents; a data cleaning module configured to clean the event data based on predetermined input parameters; a data labeling module configured to label the cleaned event data based on predetermined definitions; a pattern identification module configured to perform sequence pattern identification to identify the labeled event data; and a clustering module configured to cluster recurring identified patterns to obtain correlated events.

This and other aspects are disclosed herein.

### BRIEF DESCRIPTION OF THE DRAWINGS

The invention has other advantages and features, which will be more readily apparent from the following detailed description of the invention and the appended claims, when taken in conjunction with the accompanying drawings, in which:

FIG. 1 illustrates a system environment for improving correlation of events and alerts in a plurality of enterprise networks, according to an embodiment of the present subject matter.

FIG. 2 illustrates a simplified block diagram for improving correlation of events and alerts in a network enterprise, according to an embodiment of the present subject matter.

FIG. 3 illustrates architectural diagram for an event correlation system, according to an embodiment of the present subject matter.

FIG. 4 illustrates a system for correlating events and alerts, according to an embodiment of the present subject matter.

FIG. 5 illustrates block diagram for a method of event correlation, according to an embodiment of the present subject matter.

FIG. 6 illustrates a flow diagram for a method of correlating events and alerts, according to an embodiment of the present subject matter.

FIG. 7 illustrates a flow diagram for a method of creating labels, according to an embodiment of the present subject matter.

FIG. 8 illustrates a flow diagram for a method performing sequence pattern identification, according to an embodiment of the present subject matter.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The invention in its various embodiments proposes methods and systems for event correlation. The present subject matter is directed to removal of false positives, reduction of noisy alerts, and efficient root cause analysis. The disclosed concepts provide optimized resource utilization, implementation of shift left, and increased efficiency in IT incident management.

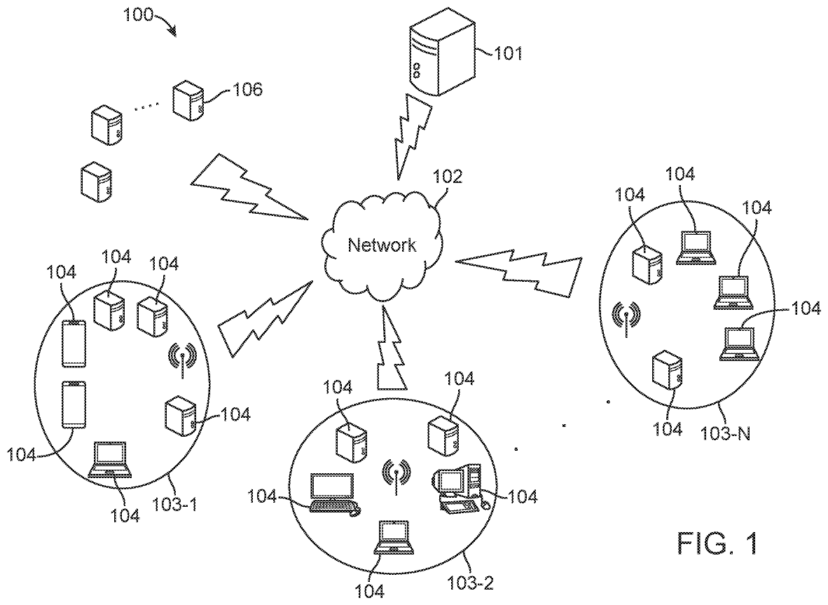

A system environment 100 for correlating events and alerts in enterprise networks is illustrated in FIG. 1, according to one embodiment of the present subject matter. The environment 100 includes an event correlation system 101, a network 102, a plurality of enterprise networks 103-1, 103-2, . . . , 103-n, communicating with each other over the network. The enterprise networks 103-1, 103-2, . . . , 103-n may include a plurality of nodes 104. “Nodes” may refer to a device or system in the network that can receive, create, store or send data along distributed network routes. In various embodiments, the plurality of nodes 104 may include computing devices, such as servers, desktop computers, laptop computers, tablet computers, personal digital assistants (PDA), smartphones, mobile phones, smart devices, appliances, sensors, or the like. The computing devices may include processing units, memory units, network interfaces, peripheral interfaces, and the like. Some or all of the components may comprise or reside on separate computing devices or on the same computing device.

In various embodiments, networks may refer generally to any type of data or telecommunication network including, without limitation, data networks, such as LANs, WANs, WLANs, MANs, internets, intranets, satellite networks, telco networks, and the like. Such networks or portions thereof may utilize any one or more different topologies, such as bus, star, ring, loop, etc., over different transmission media, such as wired/RF cable, RF wireless, millimeter wave, optical, etc.).

In some embodiments, the devices may be configured to utilize various communication protocols, such as Worldwide Interoperability for Microwave Access (WiMAX), 5G, 5G-New Radio, High Speed Packet Access (HSPA), Long Term Evolution (LTE), Global System for Mobile Communications (GSM), General Packet Radio Services (GPRS), Enhanced Data GSM Environment (EDGE), Code Division Multiple Access (CDMA), Wideband Code Division Multiple Access (WCDMA), Bluetooth, and the like. In other embodiments, various communications or networking protocols including, but not limited to, 3GPP, 3GPP2, WAP, DOCSIS, IEEE Std. 802.3, ATM, X.25, SONET, Frame Relay, SIP, TCP/UDP, FTP, RTP/RTCP, H.323, and the like, may also be used.

Further, each enterprise network 103-N may be located in different geographical locations. For example, each enterprise network 103-N here may refer to networks established in different organizations in an enterprise cluster, which may be an agglomeration of one or more of manufacturing-related organizations or companies, services-related companies, IT companies, health-related organizations, or other enterprise units.

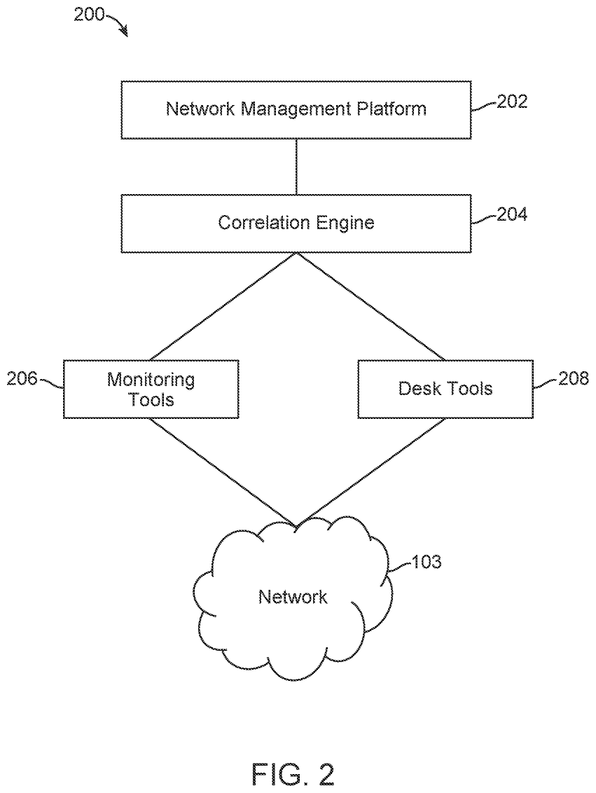

A block diagram of the event correlation platform is illustrated in FIG. 2, according to an embodiment of the present subject matter. The platform 200 includes a network management platform 202, a correlation engine 204, monitoring tools 206, and desk tools 208. The network management platform 202 may be configured to collect, consolidate, manage, and present data related to events occurring over the network 103. In various embodiments, the network management platform 202 may be implemented on the system 101. One or more network administrators may access the data presented by the network management platform 202.

The data presented to the network administrators may be processed beforehand by the correlation engine 204, which receives raw data from the plurality of nodes in the network 103. Each node in the network 103 may be installed with one or more of monitoring tools 206 and desktop tools 208. The tools may be deployed to access data from various sources including, but not limited to, applications, databases, memories of the devices or servers, processors, and the like. In some embodiments, for each tool a dedicated agent may be deployed.

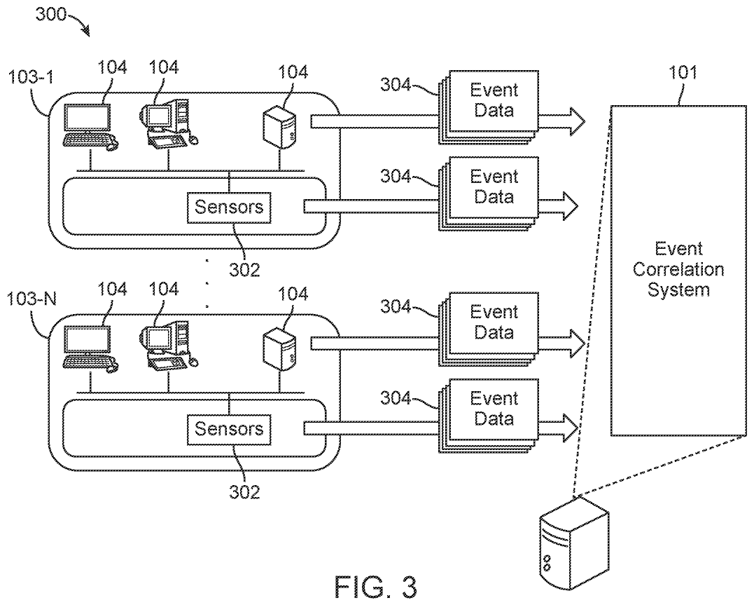

In various embodiments, a single event correlation system 101 may be used for correlating events and alerts in different networks. Alternatively, a dedicated system 101 may be used for event correlation for a particular network 103. A high level depiction of the event correlation is illustrated in FIG. 3, according to one embodiment of the present subject matter. As shown, the plurality of networks 103-1 to 103-N include one or more network nodes or devices 104, such as personal computers, laptops, servers, and the like.

In some embodiments, the plurality of nodes 104 may be connected to external monitoring devices or sensors 302 configured to implement monitoring tools 206. The sensors 302 may be configured to collect data 304 from the plurality of nodes 104. The data may include at least utilization metrics and performance metrics of the infrastructure resources associated with the nodes. The data also includes a time identifier corresponding to each metric. The time identifier may indicate the time at which the metric was captured by the monitoring tools 206.

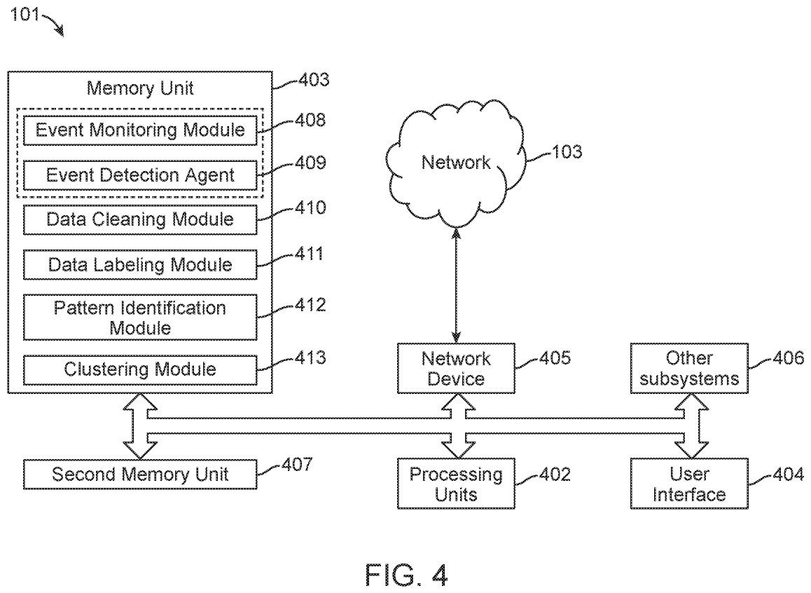

The event correlation system 101 may obtain the event data 304 from the entire network to perform event correlation. The event correlation system 101 may implement the correlation engine to perform event correlation. An architectural diagram of the event correlation system may be illustrated in FIG. 4, in accordance with an embodiment of the present subject matter.

The system 101 improves correlation of events and alerts in one or more enterprise networks 103. The system 101 includes a processor 402; a memory unit 403 coupled to the processor 402, a user interface 404, network device 406, and a second memory unit 407. The processor 402 is configured to: receive event data from a plurality of devices 104 in the network 102, wherein the event data comprises one or more of performance metrics data, alerts data, and incident data. The processor 402 is configured to clean the event data based on predetermined input parameters. The processor 402 is configured to label the cleaned event data based on predetermined definitions. The processor 402 is configured to perform sequence pattern identification to identify patterns in the labeled event data. The processor 402 is configured to cluster recurring identified patterns to obtain correlated events; and improve the accuracy of the correlated events using reinforcement learning.

In various embodiments, the memory unit 403 may include a plurality of modules configured to carry out event correlation process. The modules may be implemented as software code to be executed by the one or more processing units 402 using any suitable computer language. The software code may be stored as a series of instructions or commands in the memory unit.

In some embodiments, the memory unit 403 further includes: an event monitoring module 408 configured to monitor the event data obtained from a plurality of event detection agents 409. The memory unit includes a data cleaning module 410 configured to clean the event data based on predetermined input parameters. The memory unit includes a data labeling module 411 configured to label the cleaned event data based on predetermined definitions. The memory unit further includes a pattern identification module 412 configured to perform sequence pattern identification to identify the labeled event data. The memory unit also includes a clustering module 413 configured to cluster recurring identified patterns to obtain correlated events.

In various embodiments, the memory or storage components ay include a fixed media (e.g., RAM, ROM, a fixed hard drive, etc.) as well as removable media (e.g., a flash memory drive, a removable hard drive, an optical disk). Other examples may include dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), or any other type of media suitable for storing information. In other embodiments, the memory units may be used to carry or store desired program code means in the form of computer-executable instructions or data structures and, which can be accessed by a general purpose or special purpose computing device. The computer-executable instructions may include, for example, instructions and data which cause any general or special purpose computing device to perform a certain function or group of functions.

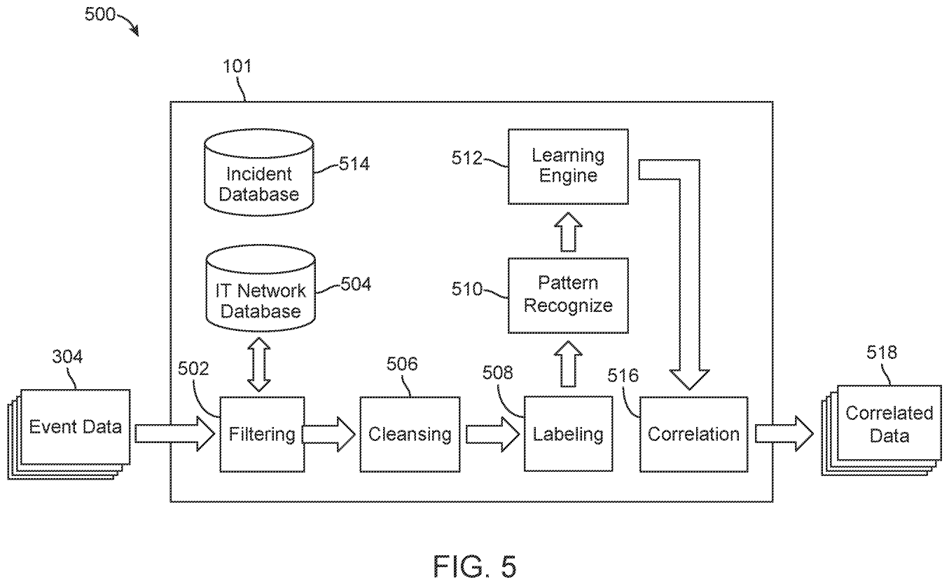

A block diagram of the event correlation process is illustrated in FIG. 5, according to one embodiment of the present subject matter. The event correlation system 101 is configured to receive the event data 304 and performs data filtration at 502. Data filtration may involve removal of unnecessary and unimportant raw data that is not relevant for event correlation. The filtration may be performed based on an IT network database 504, which stores multitude of IT related data that are categorized into unimportant raw data and event related data.

The filtered data is subjected to data cleansing 506 that involves cleaning the filtered data ingested from various sources. The cleaning may be performed using one or more algorithms that identify the parameters passed as input. For example, keyword spotting and entity extraction of text compare vectors are used to identify and clean the data. The cleansed data is then subjected to labeling 508 based on the corresponding alerts. For instance, the alerts may be clustered based on similarity and unique labels.

After labeling, pattern recognition 510 may be performed using one or more attributes, such as alert timestamp and label field. In some embodiments, the patterns may be found using support, lift, and confidence by grouping alerts in a specific window size. In some embodiments, the patterns may be found based on repeated occurrence and frequency in a moving window concept. In some embodiments, recurring patterns are clustered to obtain correlated events.

The accuracy of the correlated events may be improved using a learning engine 512. The learning engine 512 may be configured to implement machine learning techniques, such as reinforcement learning, based on an incident database 514. In some embodiments, reinforcement learning may be used to improve the accuracy of the correlation 516. One or more parameters may be used for adjusting the correlation based on the rewards that are received. For instance, windowing may be used as a parameter. If the sliding window that is set for correlation is 15 minutes and the accuracy derived from the correlation is not high, then the windowing may be adjusted and check the accuracy. If accuracy is improves then the window size is setup and the accuracy decreases then the window size is adjusted again automatically until a good accuracy is achieved. The feedbacks of the accuracy are fed back into reinforcement learning agent to make decisions on the support parameters to obtain correlated data 516.

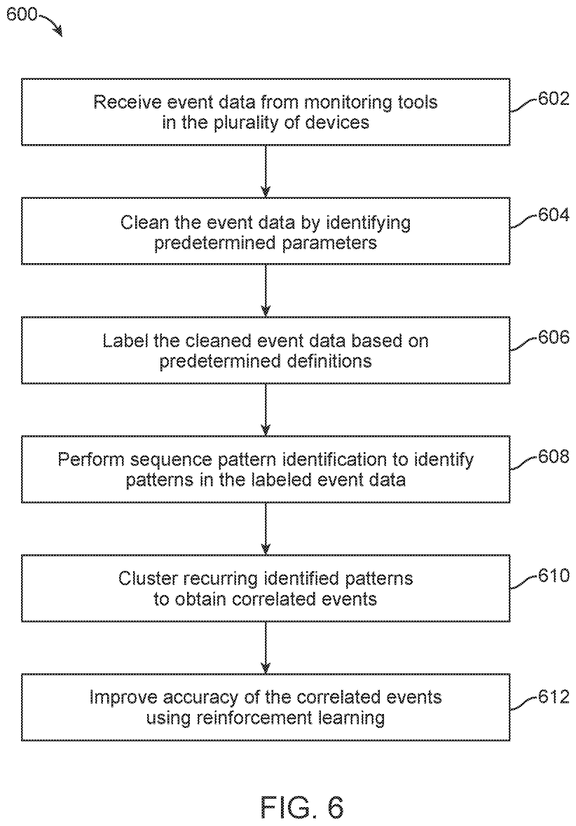

A flow diagram for a method of improving correlation of events and alerts in one or more enterprise networks is illustrated in FIG. 6, according to one embodiments of the present subject matter. A computer implemented method 600 of improving correlation of events and alerts in one or more enterprise networks 103 is disclosed. The method includes receiving, by a processor, event data from a plurality of devices 104 in the network 103 at block 602, wherein the event data comprises one or more of performance metrics data, alerts data, and incident data. Next, the method involves cleaning, by the processor, the event data based on predetermined input parameters at block 604 and labeling, by the processor, the cleaned event data based on predetermined definitions at block 606. The method further includes performing, by the processor, sequence pattern identification to identify patterns in the labeled event data at block 608, and clustering, by the processor, recurring identified patterns to obtain correlated events at block 610. The method further includes improving, by the processor, the accuracy of the correlated events using reinforcement learning at block 612.

In some embodiments, a state, an action, and a reward is applied to the correlated events, and wherein the state is the identified pattern and the action comprises improving the accuracy by tuning support parameters, windows length, and definitions. In some embodiments, outcome from the action is applied as: positive reward if there is an increase in accuracy; or negative reward if there is a decrease in accuracy. In some embodiments, labelling the cleaned event data includes: grouping alerts based on similarity, of alert descriptions using K-means clustering; assigning a label to each group based on alert creation timestamp; and creating predetermined definitions based on one or more attributes, wherein the predetermined combinations comprise tool name, application name, or device name. In some embodiments, cleaning the event data is performed using keyword spotting and entity extraction methods.

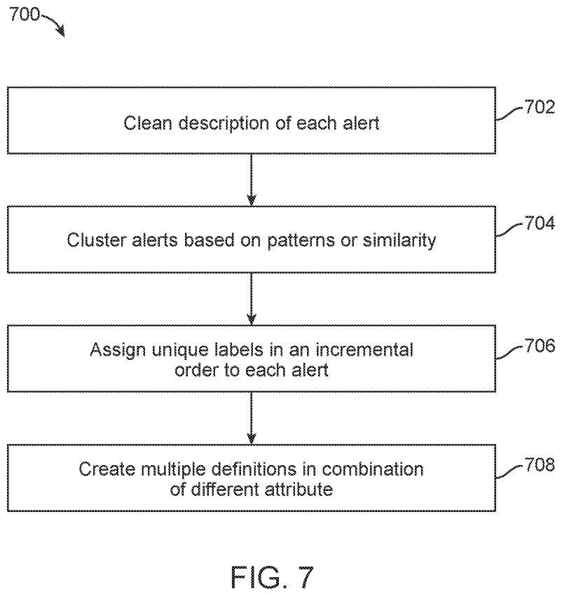

A flow diagram for a method of creating labels is illustrated in FIG. 7, according to some embodiments of the present subject matter. The method 700 includes cleaning the description of each alert at block 702. The alerts may be clustered based on patterns or similarity at block 704. The clustering may be performed by matching the alerts based on cleaned description using K-means clustering algorithm. The method includes assigning unique labels in an incremental order to each unique alert at block 706. The assigning may be based on alert created time or timestamps associated with the alert. Next, the method involves creating multiple definitions in combination of different attributes at block 708. For example, definitions may be created for description, device name with description, application name with description, and tool name with description.

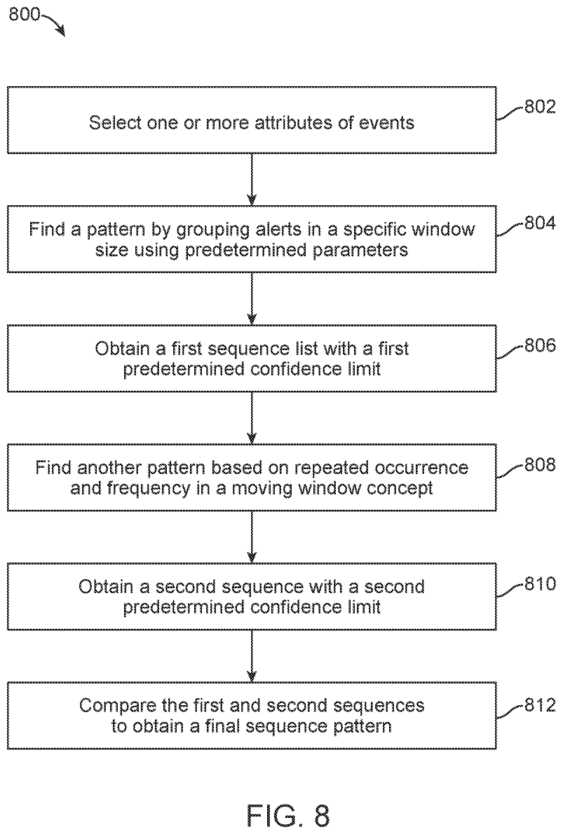

A flow diagram for a method of sequence pattern identification is illustrated in FIG. 8, according to one embodiment of the present subject matter. The method 800 includes selecting one or more attributes of events at block 802. In some embodiments, the attributes may include alert created time or label field. The method includes obtaining a pattern by grouping alerts in a specific window size using predetermined parameters at block 804. For example, APRIORI may be used to find pattern using parameters, such as support, lift, and confident by grouping alerts in a specific window size.

The method includes obtaining a first sequence list with a first predetermined confidence limit at block 806. For example, APRIORI throws output with some confidence limit. The method includes obtaining a pattern based on repeated occurrence and frequency in a moving window concept at block 808. For example, WINEPI may be used to find pattern based on the repeated occurrence and frequency in a moving window concept. The method further includes obtaining a second sequence with a second predetermined confidence limit at block 810. In various embodiments, the window size is adjustable in both WINEPI and APRIORI. Further, the method includes comparing the first and second sequences to obtain a final sequence pattern at block 812. For example, if the same sequence is extracted from both the algorithms then the one with maximum confidence is selected.

According to another embodiment of the present subject matter, a computer program product having non-volatile memory therein, carrying computer executable instructions stored therein for improving correlations of events and alerts is disclosed. The instructions include receiving event data from a plurality of devices in the network, wherein the event data comprises one or more of performance metrics data, alerts data, and incident data. The instructions include cleaning the event data based on predetermined input parameters and labeling the cleaned event data based on predetermined definitions. The instructions further include performing sequence pattern identification to identify patterns in the labeled event data, and clustering recurring identified patterns to obtain correlated events. The instructions include improving the accuracy of the correlated events using reinforcement learning.

In various embodiments, the computer program product may implemented using a physical storage media, such as RAM, ROM, EEPROM, CD-ROM or other storage such as optical disk storage, non-volatile storage, magnetic disk storage or other magnetic storage devices, or any other medium. In some embodiments, the memory or storage components may include a fixed media (e.g., RAM, ROM, a fixed hard drive, etc.) as well as removable media (e.g., a flash memory drive, a removable hard drive, an optical disk). Other examples may include dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), or any other type of media suitable for storing information. In other embodiments, the memory units may be used to carry or store desired program code means in the form of computer-executable instructions or data structures and, which can be accessed by a general purpose or special purpose computing device. The computer-executable instructions may include, for example, instructions and data which cause any general or special purpose computing device to perform a certain function or group of functions.

### Example

Some examples of the data cleaning process are explained using examples. For example, some of the data tabulated below provides before and after cleaning process.

TABLE 1
Examples of data before and after cleaning

| Before Cleaning | After Cleaning |
|---|---|
| “GavelDescription_s”: | “Description1_s”: event |
| BC-Major-Event | monitoring system event |
| Monitoring-System\|\|Event | raised microsoft windows |
| Raised\|\|4.0.Microsoft- | security kerberos the |
| Windows-Security-Kerberos, | kerberos client received |
| 2019-04-04T10:37:43Z, | krbaperrmodified error from |
| The Kerberos client received a | the server ctkf the target |
| KRB_AP_ERR_MODIFIED | name used was cifs ctkf |
| error from the server | global loc this indicates that |
| | the target server failed |
| ct3kf62$. The target | to decrypt the ticket provided |
| name used was | by the client this can |
| cifs/CT3KF62.global.loc. | occur when the target server |
| This indicates that the | principal name spn is |
| target server failed to decrypt | registered on an account other |
| the ticket provided by | than the account the |
| the client. This can occur | target service is using ensure |
| when the target server | that the target spn is |
| principal name (SPN) is | only registered on the account |
| registered on an account | used by the server this |
| other than the account the | error can also happen if the |
| target service is using. | target service account |
| Ensure that the target SPN | password is different than |
| is only registered on the | what is configured on the |
| account used by the server. | kerberos key distribution |
| This error can also | center kdc for that target |
| happen if the target service | service ensure that the service |
| account password is | on the server and the |
| different than what is configured | kdc are both configured to |
| on the Kerberos Key | use the same password if |
| Distribution Center (KDC)for | the server name is not fully |
| that target service. | qualified and the target |
| Ensure that the service on | domain global loc is different |
| the server and the KDC are | from the client domain |
| both configured to use the | global loc check if there are |
| same password. If the | identically named server |
| server name is not fully | accounts in these two |
| qualified, and the target | domains or use the fully |
| domain (GLOBAL.LOC) is | qualified name to identify |
| different from the client | the server error |
| domain (GLOBAL.LOC), | |
| check if there are | |
| identically named server | |
| accounts in these two | |
| domains, or use the | |
| fully-qualified name to identify | |
| the server., Error”, | |
| “GavelDescription_s: | “description1_s”: mount used |
| Major-MC Mount Used | monitoring mount |
| Monitoring-Mount Used | used to disk is in risk mount |
| 90 TO 100%\|\|Disk is in | used to usracig sapdb sd |
| risk Mount used 90 TO 100% | sapdata |
| \|\|USRACIG982,/Sapdb/ | |
| SD4/sapdata1,91.0 | |
| “GavelDescription_s: | “description1_s: unix high |
| MC-Minor-UNIX High | percentage memory |
| percentage memory used\|\|\|\|Total | used total memory |
| Memory Utilization | utilization percent to |
| (Percent): 90 To 95 | |
| \|\|93.57957076412492 | |
| “GavelDescription_s”: Alarm | “description1_s”: alarm |
| ‘Virtual machine CPU | virtual machine cpu |
| usage’ on usplx9011-prd1 | usage on usplx prd |
| “GavelDescription_s: Alarm | “description1_s”: alarm |
| ‘Virtual machine CPU | virtual machine cpu |
| usage’ on uswaxddd116 | usage on uswaxddd |

As shown in Table 1, the “before cleaning data” includes several cosmetic and unimportant information, such as “4.0, Microsoft-Windows-Security-Kerberos, 2019-04-04T10:37:43Z”, “CT3KF62”, or “93.57957076412492”. Such data are removed during the data cleaning process and only the important and relevant information is retained.

Further, WINEPI and APRIORI algorithms were used for assigning weightages to each of the alerts based on occurrences. The correlated elements are extracted through algorithm based on 3 major variables (support, confidence, and lift). The table below shows an example list of events on and alerts on RHS. The corresponding parameters, i.e., the support, confidence, and lift of the correlation are also provided.

TABLE 2
Event correlation and associated support, confidence, and lift

| LHS | | RHS | Support | Confidence | Lift | Count |
|---|---|---|---|---|---|---|
| {q, x} | => | {w} | 0.2 | 1 | 1 | 1 |
| {a, b} | => | {c} | 0.6 | 1 | 1 | 3 |
| {a, c} | => | {b} | 0.6 | 0.75 | 0.9375 | 3 |
| {b, c} | => | {a} | 0.6 | 0.75 | 0.9375 | 3 |
| {a, b} | => | {w} | 0.6 | 1 | 1 | 3 |
| {a, w} | => | {b} | 0.6 | 0.75 | 0.9375 | 3 |
| {b, w} | => | {a} | 0.6 | 0.75 | 0.9375 | 3 |
| {a, b} | => | {x} | 0.6 | 1 | 1 | 3 |
| {a, x} | => | {b} | 0.6 | 0.75 | 0.9375 | 3 |
| {b, x} | => | {a} | 0.6 | 0.75 | 0.9375 | 3 |
| {a, c} | => | {w} | 0.8 | 1 | 1 | 4 |
| {a, w} | => | {c} | 0.8 | 1 | 1 | 4 |
| {c, w} | => | {a} | 0.8 | 0.8 | 1 | 4 |
| {a, c} | => | {x} | 0.8 | 1 | 1 | 4 |
| {a, x} | => | {c} | 0.8 | 1 | 1 | 4 |
| {c, x} | => | {a} | 0.8 | 0.8 | 1 | 4 |
| {a, w} | => | {x} | 0.8 | 1 | 1 | 4 |
| {a, x} | => | {w} | 0.8 | 1 | 1 | 4 |
| {w, x} | => | {a} | 0.8 | 0.8 | 1 | 4 |
| {b, c} | => | {w} | 0.8 | 1 | 1 | 4 |
| {b, w} | => | {c} | 0.8 | 1 | 1 | 4 |

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here.

While the invention has been disclosed with reference to certain embodiments, it will be understood by those skilled in the art that various changes may be made and equivalents may be substituted without departing from the scope of the invention. In addition, many modifications may be made to adapt to a particular situation or material the teachings of the invention without departing from its scope.

We claim:

1. A computer implemented method (600) of improving correlation of events and alerts in one or more enterprise networks (103), the method comprising:
receiving, by a processor (402), event data from a plurality of devices (104) in the network (103), wherein the event data comprises one or more of performance metrics data, alerts data, and incident data;
cleaning, by the processor (402), the event data based on predetermined input parameters;
labelling, by the processor (402), the cleaned event data based on predetermined definitions;
performing, by the processor (402), sequence pattern identification to identify patterns in the labelled event data;
clustering, by the processor (402), recurring identified patterns to obtain correlated events; and
improving, by the processor (402), the accuracy of the correlated events using reinforcement learning.

2. The method of claim 1, wherein a state, an action, and a reward is applied to the correlated events, and wherein the state is the identified pattern and the action comprises improving the accuracy by tuning support parameters, windows length, and definitions.

3. The method of claim 2, wherein outcome from the action is applied as:
positive reward if there is an increase in accuracy; or
negative reward if there is a decrease in accuracy.

4. The method of claim 1, wherein labelling the cleaned event data comprises:
grouping alerts based on similarity of alert descriptions using K-means clustering;
assigning a label to each group based on alert creation timestamp;
creating predetermined definitions based on one or more attributes, wherein the predetermined combinations comprise tool name, application name, or device name.

5. The method of claim 1, wherein cleaning the event data is performed using keyword spotting and entity extraction methods.

6. A system (101) for improving correlation of events and alerts in one or more enterprise networks (103), the system (101) comprising:
a processor (402);
a memory unit (403) coupled to the processor (402), wherein the processor (402) is configured to:
receive event data from a plurality of devices (104) in the network (103), wherein the event data comprises one or more of performance metrics data, alerts data, and incident data;
clean the event data based on predetermined input parameters;
label the cleaned event data based on predetermined definitions;
perform sequence pattern identification to identify patterns in the labelled event data;
cluster recurring identified patterns to obtain correlated events; and
improve the accuracy of the correlated events using reinforcement learning.

7. The system (101) of claim 6, wherein the memory unit (403) comprises:
an event monitoring module (408) configured to monitor the event data obtained from a plurality of monitoring agents;
a data cleaning module (410) configured to clean the event data based on predetermined input parameters;
a data labelling module (411) configured to label the cleaned event data based on predetermined definitions;
a pattern identification module (412) configured to perform sequence pattern identification to identify the labelled event data; and
a clustering module (413) configured to cluster recurring identified patterns to obtain correlated events.
